(19) United States
(12) Patent Application Publication
(10) Pub. No.: US 2008/0082354 A1
(43) Pub. Date: Apr. 3, 2008

(54) COMPLIANCE ASSESSMENT REPORTING SERVICE

(76) Inventors: Simon John Hurry, Foster City, CA (US); John Foxe Sheets, San Francisco, CA (US)

Correspondence Address: MAYER BROWN LLP, P.O. Box 2828, Chicago, IL, 60690-2828, US

(21) Appl. No.: 11/838,146

(22) Filed: Aug. 13, 2007

Related U.S. Application Data
(60) Provisional application No. 60/822,155, filed on Aug. 11, 2006.

(51) Int. Cl. G06Q 30/00; G06Q 99/00

(52) U.S. Cl. 705/1

(57) ABSTRACT

Disclosed herein is a method for providing assurance information regarding a business entity to a customer for an electronic transaction. The method comprises submitting a compliance token to a certificate authority as part of a certificate signing request wherein the compliance token comprises an assessment result describing the business entity's level of compliance with an assurance policy, as determined by an assessor, receiving an assurance certificate from the certificate authority, wherein the certificate includes the compliance token, and providing the assurance certificate to a customer in order to provide security information to the customer as part of an electronic transaction.

### CROSS-REFERENCE TO RELATED APPLICATIONS

The present application claims priority to U.S. Provisional Application No. 60/822,155, filed on Aug. 11, 2006 and entitled “Compliance Assessment Reporting Service.”

### BACKGROUND OF THE INVENTION

Certificates are provided by online certificate authorities to provide increased consumer confidence in, for example, a destination website. For example, Secure Sockets Layer (SSL) is a cryptographic protocol which provides secure communications on the Internet for such things as e-mail, electronic commerce transactions and other data transfers. SSL provides endpoint authentication and communications privacy over the Internet using cryptography. In typical use, only the server is authenticated (i.e., its identity is ensured) while the client remains unauthenticated; mutual authentication requires public key infrastructure (PKI) deployment to clients. The SSL protocol allows client/server applications to communicate in a way designed to prevent eavesdropping, tampering and message forgery. As such, business entities often apply for SSL certificates or other assurance certificates in order to demonstrate a level of security to customers.

When a business entity desires to obtain a certificate for their customer facing web server, the business entity generates a Certificate Signing Request (CSR) for the server where the certificate will be installed. The CSR is generated using a primarily automated process. The CSR generation process creates an RSA key pair corresponding to the server. The public key is sent to a certificate authority with other business and server information. The certificate authority signs the public key with a certificate authority key and returns the signed key together with other data as a certificate.

When issuing a certificate, it is important that a certificate authority, such as, for example, VeriSign, can correctly identify the party to whom the certificate is issued. Moreover, it is important that the certificate authority verifies that the receiver of the certificate is legitimate. For example, VeriSign only issues SSL certificates for online business purposes after performing a number of authentication procedures. Such authentication procedures include a) verifying the requester's identity and confirming that the requester is a legal entity; b) confirming that the requester has the right to use the domain name included in the SSL certificate; and c) verifying that the individual who requested the SSL certificate was authorized to do so on behalf of the business entity.

Despite these safeguards, a number of problems can occur using the existing process for issuing certificates. One problem is that the validity of an SSL certificate or another assurance certificate is based on information that a business entity and/or business owner provides to the certificate authority. As such, a certificate authority still depends upon the veracity of the third party requester. In addition, the assurance certificate merely authenticates the business entity's server and provides data protection between the client and the server. While the data is protected, a consumer has no assurance that the business entity and/or business owner is legitimate. The consumer is also not provided with any other assurance information relating to the business entity. As such, using the present certificate authorization process is inadequate.

Further, there are also significant shortcomings in providing assurance information to consumers at brick and mortar establishments. For instance, a dentist's office may have the required credentials and/or certifications posted on a wall. However, there is no guarantee to the consumer that the credentials and/or certifications are legitimate or still in effect.

Known ways of verifying the identity of the business entity and/or business owner include requiring the business owner to physically appear at the certification authority with identifying documentation; physically delivering copies of a business entity's articles of incorporation and the like to the certificate authority and/or contacting third party references that might also need to be verified. However, such procedures are time consuming and burdensome upon business entities and certificate authorities.

What are needed are methods and systems for raising confidence in a certificate issued by a certificate authority using business entity information provided in a certificate signing request.

A need exists for methods and systems for increasing consumer confidence in electronic financial transactions with certified business entity servers.

A need exists for methods and systems for increasing consumer confidence in brick and mortar transactions.

A further need exists for methods and systems for encapsulating third-party compliance information in a data security (or other policy) compliance certificate.

The present disclosure is directed to solving one or more of the above-listed problems.

### SUMMARY

Before the present methods are described, it is to be understood that this invention is not limited to the particular methodologies or protocols described, as these may vary. It is also to be understood that the terminology used herein is for the purpose of describing particular embodiments only, and is not intended to limit the scope of the present disclosure, which will be limited only by the appended claims.

It must be noted that as used herein and in the appended claims, the singular forms “a,” “an,” and “the” include plural reference unless the context clearly dictates otherwise. Thus, for example, reference to a “certificate” is a reference to one or more certificates and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

A business entity may request an assessment of compliance to a specific security standard or policy from a qualified assessor. The assessor may audit the business entity based on an assurance policy to determine one or more vulnerabilities in the business entity's operations. Results of the audit process may be sent to an industry consortium. In an embodiment, the industry consortium and the assessor may be the same entity. The audit results may include, for example and without limitation, the date of the assessment, a business entity identifier, a compliance result string and information denoting the equipment that was assessed. The qualified assessor may sign the assessment results and return the signed assessment results to the business entity. The business entity may then apply for or renew a certificate from a certificate authority by including the signed assessment results in a CSR. In an alternate embodiment, the qualified assessor may send the assessment results directly to the certificate authority. The certificate authority may verify the signed assessment results and include the data in a certificate that is returned to the business entity server.

In an embodiment, a method for providing assurance information regarding a business entity to a customer for an electronic transaction may include requesting a qualified assessor to perform a review of a business entity's operations to determine compliance with an assurance policy, receiving a signed assessment result from the qualified assessor, signing the result with the assessor's private key to form a compliance token, submitting the compliance token as part of a certificate signing request to a certificate authority, receiving a high assurance certificate including the signed assessment result from the certificate authority, and using the certificate to provide security information to a customer as part of an electronic transaction.

### BRIEF DESCRIPTION OF THE DRAWINGS

FIG. 1 depicts a high-level overview of an exemplary process of obtaining a high assurance certificate according to an embodiment.

FIG. 2 depicts an exemplary process of obtaining a high assurance certificate according to an embodiment.

FIG. 3 depicts a setup process between a compliance assessor and a certificate authority according to an embodiment.

FIG. 4 depicts an exemplary process for displaying compliance information for a business entity via a client browser according to an embodiment.

FIG. 5 depicts an exemplary process for obtaining a high assurance certificate at a brick and mortar establishment according to a preferred embodiment.

FIG. 6 depicts an exemplary process for displaying compliance information to a customer of a brick and mortar establishment according to a preferred embodiment.

### DETAILED DESCRIPTION OF THE INVENTION

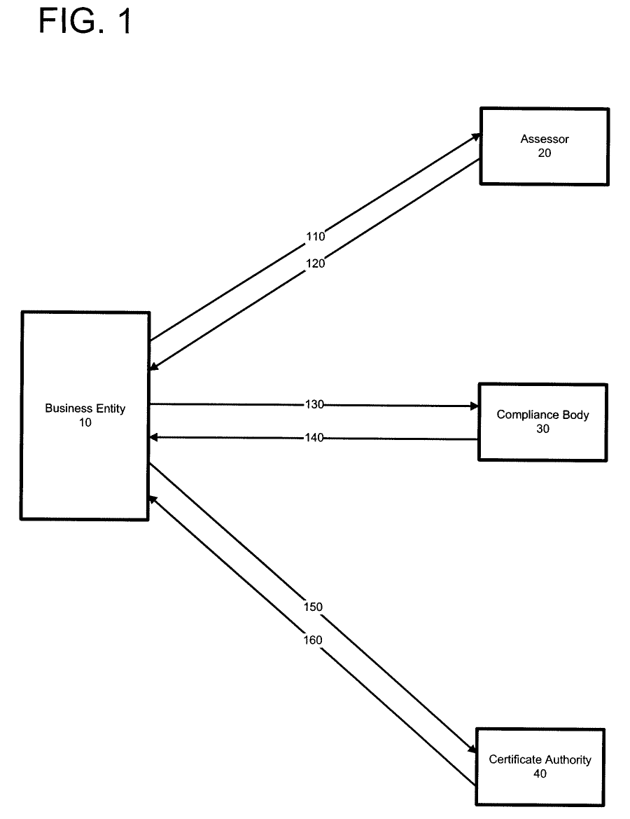

FIG. 1 depicts a high-level overview of an exemplary process of obtaining a high assurance certificate according to an embodiment. The various aspects of FIG. 1 will be described in more detail below. The compliance reporting service according to a preferred embodiment comprises a business entity 10, assessor 20, compliance body 30, and certificate authority 40. First, the business entity 10 may request 110 a compliance assessment from an assessor 20. The assessor 20 then performs the assessment and transmits 120 the results of the assessment to the business entity 10. The business entity 10 may submit 40 the results of the assessment to a compliance body 30. The compliance body 30 may then transmit 50 a compliance token to the business entity 10 if the results of the assessment are satisfactory to the compliance body 30. When the business entity 10 wishes to demonstrate compliance to a certificate authority, the business entity 10 transmits 150 the compliance token to a certificate authority 40. The certificate authority 40 may then verify the authenticity of the compliance certificate, then the certificate authority 40 may transmit 160 an assurance certificate to the business entity 10.

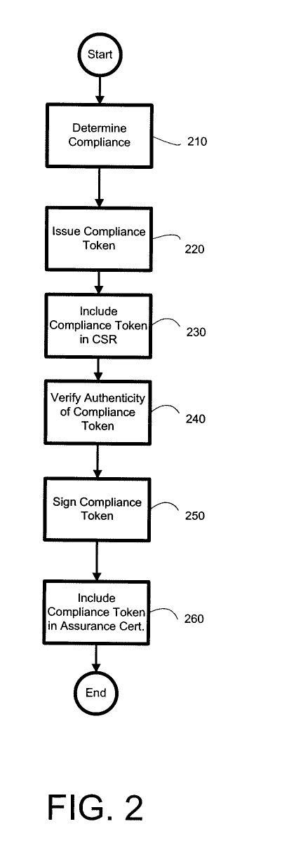

FIG. 2 depicts an exemplary process of obtaining a high assurance certificate according to an embodiment. As shown in FIG. 2, a requester, such as a business entity, may securely provide identification information to enable verification of the requester's identity without physically appearing or presenting physical documents to a certificate authority. In order to achieve verification of the business entity's identity, the business entity may apply to a qualified assessor that determines 210 compliance with an industry and/or security policy. For example, a business entity may seek to comply with the Payment Card Industry Data Security Standard (PCI DSS). The business entity seeking such compliance may initiate an audit of its online security procedures. Alternate and/or additional compliance audits, such as an audit to determine compliance with the Health Insurance Portability and Accountability Act (HIPAA), may be performed. One or more qualified assessors may each perform one or more audits of the business entity's operations depending on the needs and desires of the business entity and/or consumers accessing the business entity's services.

A qualified assessor may set one or more standards to be satisfied when auditing a business entity's server. As part of an audit, the assessor may seek to access particular information that is relevant to the compliance certification on the business entity's server. For example, a HIPAA compliance qualified assessor may attempt to access healthcare related information stored on the business entity's server and/or verify that no user can access other users' healthcare related information. A similar audit may be performed with respect to account information when, for example, applying for an audit pertaining to the financial transaction industry. As stated above, additional and/or alternate audits may be performed to determine compliance with differing requirements.

Upon successful completion of an audit of the business entity's system, the qualified assessor may issue 220 a digital compliance token to the business entity. The digital compliance token may include a certificate of compliance signed using, for example, the qualified assessor's private key. The compliance token may further include, for example, the identity of the qualified assessor for which the token is issued and/or particular processes and/or safeguards that are implemented on the business entity's servers that enabled the qualified assessor to determine that the audit was successful.

The business entity may then include 230 each compliance token in a Certificate Signing Request submitted to the certificate authority to show compliance with the applicable standards. In an alternate embodiment, the qualified assessor may transmit the digital compliance token directly to a certificate authority. Such an embodiment may be performed, for example, when the business entity has directed the qualified assessor to do so when the third-party compliance token is sought.

The certificate authority may verify 240 that the compliance tokens are authentic. In addition, the certificate authority may audit the business entity website to determine compliance with its own requirements. If the compliance tokens are determined to be authentic and/or the certificate authority determines that the business entity website complies with its requirements, the certificate authority may sign 250 the tokens with a certificate authority private key and include 260 the compliance tokens as part of the information in the assurance certificate.

The exemplary process described above may provide substantially more useful information regarding the business entity's server than an assurance certificate provides alone. For example, an SSL certificate that includes compliance tokens may provide third party verification of the business entity and may result in a much higher level of customer assurance for communication with the business entity. Such verification may be extended to a plurality of regulatory and/or other data compliance measures sought by consumers in order to “trust” a particular business entity.

The exemplary process is described with reference to an assurance certificate. However, it will be apparent to those of ordinary skill in the art that the final certificate authority may certify compliance with any standard. As such, it is not intended that the invention be limited to the embodiments described, but that any compliance organization may issue a certificate encapsulating compliance tokens.

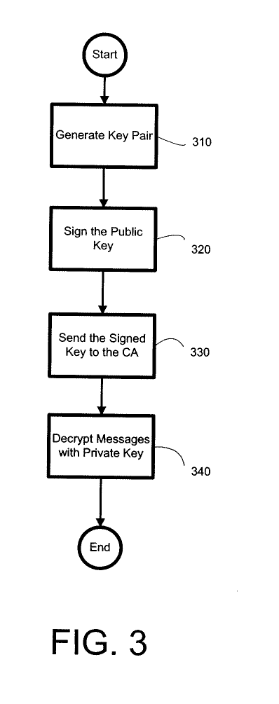

FIG. 3 depicts a setup process between a compliance assessor and a certificate authority according to an embodiment. As shown in FIG. 3, a third party qualified assessor may generate 310 an assessor key pair. For example, a public key and a private key may be generated using the RSA algorithm. The third party qualified assessor may optionally digitally sign 320 the public key and send 330 the (signed) public key to a certificate authority. The certificate authority may use the public key to decrypt 340 messages signed by the qualified assessor with its private key. Alternate public key encryption/decryption algorithms may also be used within the scope of this disclosure as will be apparent to those of ordinary skill in the art. In addition, private key encryption/decryption algorithms may also be used. Or, the compliance assessor may receive a certified key pair to be used for signing from one or more certificate authorities.

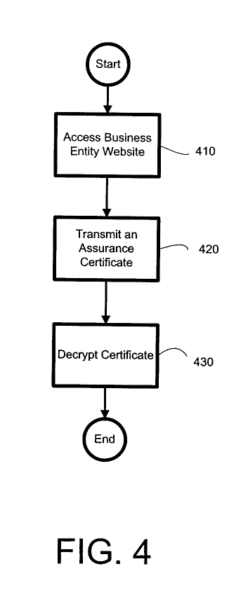

FIG. 4 depicts an exemplary process for display compliance information for a business entity via a client browser according to an embodiment. As shown in FIG. 4, a client browser, such as, for example and without limitation, Microsoft Internet Explorer® or Netscape Navigator®, may be used to access 410 a business entity's website that includes a compliance certificate. The client browser may include one or more root keys associated with one or more certificate authorities. Each root key may be stored in a client computer at the time that the client browser is installed. When the client browser accesses the business entity's website, the business entity may transmit 420 an assurance certificate to the client browser. The root key for the certificate authority that signed the assurance certificate may be used to decrypt 430 the certificate. The certificate may then be verified 340 by the client browser. If the verified certificate is not determined to be a high assurance certificate, the client browser may display a warning message to the client that the business entity's website does not include third party verification, that certain preferred safeguards are not incorporated into the business entity's website and/or the like. Conversely, if the verified certificate is determined to be a high assurance certificate, the client browser may display compliance data corresponding to the compliance tokens resulting from the one or more third party qualified assessors' and/or industry consortiums' audits.

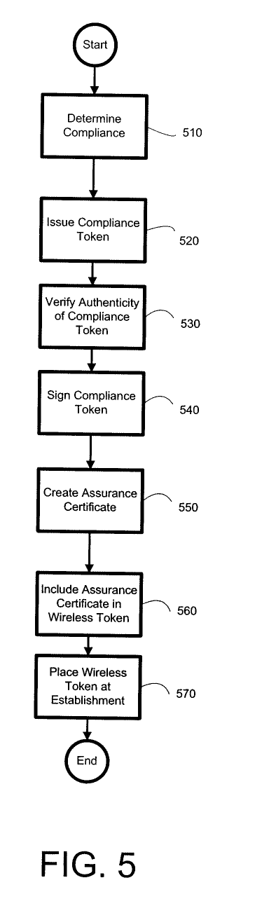

In an alternative embodiment of the present invention, customers at brick and mortar establishments may be provided with assurance information. Referring to FIG. 5, a qualified assessor may determine 510 a brick and mortar establishment's compliance with an industry and/or security policy. The qualified assessor may then issue 520 a digital compliance token to a certificate authority based on the result of the assessment. The digital compliance token preferably includes a compliance result signed using the qualified assessor's private key. The compliance token may further include, for example, the identity of the qualified assessor that issued the token and/or particular processes and/or safeguards that are implemented by the brick and mortar establishment that enabled the qualified assessor to determine that the audit was successful. The compliance token may further include the qualified assessor's public key. The certificate authority may verify 530 that the compliance token is authentic using the qualified assessor's public key. If the compliance token is determined to be authentic, the certificate authority may sign 540 the compliance token with the certificate authority's private key, thereby creating 550 an assurance certificate. The assurance certificate may then be incorporated 560 into a wireless token built into a security decal or similar device. The wireless token may implement a wireless communication protocol such as, for instance, near field communication, radio-frequency identification, or similar communication protocols. The security decal may then be placed 570 at a brick and mortar establishment. The security decal is preferably placed at a highly visible location, such as an entrance or a front window.

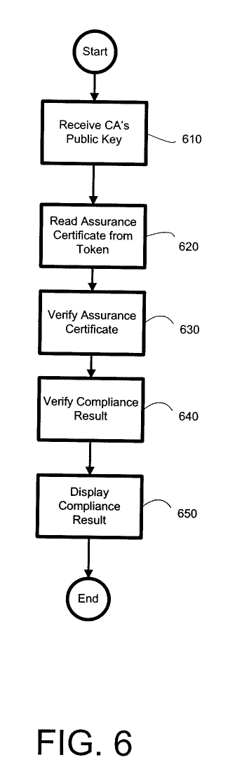

Referring to FIG. 6, a customer may verify the brick and mortar establishment's compliance with an industry and/or security policy. A customer's portable electronic device may receive 610 the certificate authority's public key. The customer's portable electronic device may be, for example, a cellular phone, personal data assistant, portable e-mail device, or similar device. When a customer arrives at a brick and mortar establishment, the portable electronic device may then be used to read 620 the assurance certificate from the wireless token. The portable electronic device may then use the certificate authority's public key to verify 630 that the assurance certificate was signed by the certificate authority. Then, the portable electronic device may use the qualified assessor's public key to verify 640 the authenticity of the compliance result using the qualified assessor's public key. Finally, the portable electronic device may display 650 the compliance result to the customer. In the above manner, an existing online certificate authority/qualified assessor system may be extended to brick and mortar establishments.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method for providing assurance information regarding a business entity to a customer for an electronic transaction, the method comprising:
submitting a compliance token to a certificate authority as part of a certificate signing request wherein the compliance token comprises an assessment result describing the business entity's level of compliance with an assurance policy, as determined by an assessor;
receiving an assurance certificate from the certificate authority, wherein the certificate includes the compliance token; and
providing the assurance certificate to a customer in order to provide security information to the customer as part of an electronic transaction.

2. The method of claim 1, wherein the assurance policy is the Payment Card Industry Data Security Standard.

3. The method of claim 1, wherein the assurance the assurance policy assures compliance with the Health Insurance Portability and Accountability Act.

4. The method of claim 1, wherein the compliance token further includes the identity of the assessor.

5. The method of claim 1, wherein the compliance token further comprises:
the date of the assessment; and
an identity of the business entity.

6. The method of claim 1, wherein the assessor has provided the assurance policy.

7. The method of claim 1, wherein the compliance token further comprises an indication that the assessor is in good standing.

8. The method of claim 1, wherein the compliance token further comprises an indication that the assessment result was generated in compliance with required procedures or practices.

9. A method for providing assurance information regarding a business entity to a customer for an electronic transaction, the method comprising:
requesting that an assessor perform a review of the business entity's operations to determine compliance with an assurance policy;
receiving an assessment result from the assessor, signed with the assessor's private key;
submitting the assessment result to a compliance body;
receiving a digital compliance token from the compliance body, wherein the compliance token comprises the assessment result and is signed with the compliance body's private key;
submitting the compliance token to a certificate authority as part of a certificate signing request;
receiving an assurance certificate from the certificate authority, wherein the certificate includes the compliance token; and
providing the assurance certificate to a customer in order to provide security information to the customer as part of an electronic transaction.

10. The method of claim 9, wherein the assurance policy is the Payment Card Industry Data Security Standard.

11. The method of claim 9, wherein the assurance policy assures compliance with the Health Insurance Portability and Accountability Act.

12. The method of claim 9, wherein the compliance token further includes the identity of the assessor.

13. The method of claim 9, wherein the compliance token further comprises:
the date of the assessment; and
an identity of the business entity.

14. The method of claim 9, wherein the assessor and the compliance body are the same entity.

15. The method of claim 9, wherein the compliance token further comprises an indication that the assessor is in good standing.

16. The method of claim 9, wherein the compliance token further comprises an indication that the assessment result was generated in compliance with procedures required by the compliance body.

17. A method for providing assurance information regarding a brick and mortar establishment to a customer using a portable electronic device, the method comprising:
receiving a certificate authority's public key on the portable electronic device;
reading, from a wireless token situated at the establishment, an assurance certificate containing a compliance result from a qualified assessor into the portable electronic device;
verifying that the assurance certificate was signed by the certificate authority; and
displaying, on the portable electronic device, the compliance result to the customer.

18. The method of claim 17, further comprising verifying the authenticity of the compliance result using the qualified assessor's public key.

19. The method of claim 7, wherein the assurance certificate further includes the identity of the qualified assessor.

20. The method of claim 17, wherein the assurance certificate further comprises:
the date of an assessment; and
an identity of the brick and mortar establishment.

21. The method of claim 17, wherein the qualified assessor and the certificate authority are the same entity.

22. The method of claim 17, wherein the assurance certificate further comprises an indication that the qualified assessor is in good standing.

23. The method of claim 17, wherein the assurance certificate further comprises an indication that the compliance result was generated in compliance with procedures required by the compliance body.
